(19) United States
(12) Patent Application Publication
(10) Pub. No.: US 2008/0008559 A1
(43) Pub. Date: Jan. 10, 2008

(54) Paper tack

(76) Inventor: Mark Ross, Merriam, KS (US)

Correspondence Address: Mark D. Ross, 8200 W. 58th Street, Merriam, KS, 66202, US

(21) Appl. No.: 11/803,736

(22) Filed: May 16, 2007

Related U.S. Application Data
(63) Continuation of application No. 29/262,693, filed on Jul. 10, 2006, now Pat. No. D545903.

(51) Int. Cl. F16B 15/02

(52) U.S. Cl. 411/483

(57) ABSTRACT

An apparatus is provided for a paper tack. The apparatus has a set of coiled loops that taper to a pointed end that is substantially perpendicular to the set of coiled loops. The apparatus may be inserted into a surface at the pointed end. The apparatus may hold a thin material such as paper between two adjacent sides of the set of coiled loops.

### CROSS-REFERENCE TO RELATED APPLICATIONS

This is a continuation of design application Ser. No. 29/262,693 filed Jul. 10, 2006 which claims the benefit under 35 U.S.C. 120. The design application Ser. No. 29/262,693 is herein incorporated by reference.

### STATEMENT REGARDING FEDERALLY SPONSORED RESEARCH OR DEVELOPMENT

Not applicable

### SUMMARY OF THE INVENTION

The present invention generally relates to a paper tack.

In a first aspect, an apparatus for embedding into a first object is provided that includes a string-shaped material having coiled loops abutting each other for holding a second object between a pair of coiled loops. The string-shaped material extends a first linear piece from one end of the coiled-loops radially and perpendicular to one member of the coiled loops. The string-shaped material extends a second linear piece angularly and substantially perpendicular to the first linear piece. The second linear piece extends outwardly away from the coiled loops. The second linear piece has a substantially conical edge such that it embeds into the first object.

In another aspect, an apparatus for holding an item is provided that includes a strand of material with a circuitous shape. A substantial first portion of a first side of the strand of material touches a substantial second portion of an opposite side of the strand of material. A first linear piece is located at a first end of the strand of material. The first linear piece extends outwardly from the strand of material and comprises a pointed end.

### BRIEF DESCRIPTION OF THE SEVERAL VIEWS OF THE DRAWINGS

The present invention is described in detail below with reference to the attached drawing figures, wherein:

FIG. 1 is a perspective view according to an implementation of an embodiment of the present invention;

FIG. 2 is a top-side elevational view according to an implementation of an embodiment of the present invention;

FIG. 3 is a front elevational view according to an implementation of an embodiment of the present invention;

FIG. 4 is a right-side elevational view according to an implementation of an embodiment of the present invention;

FIG. 5 is a bottom elevational view according to an implementation of an embodiment of the present invention;

FIG. 6 is a back elevational view according to an implementation of an embodiment of the present invention; and

FIG. 7 is a left-side elevational view according to an implementation of an embodiment of the present invention.

### DETAILED DESCRIPTION OF THE INVENTION

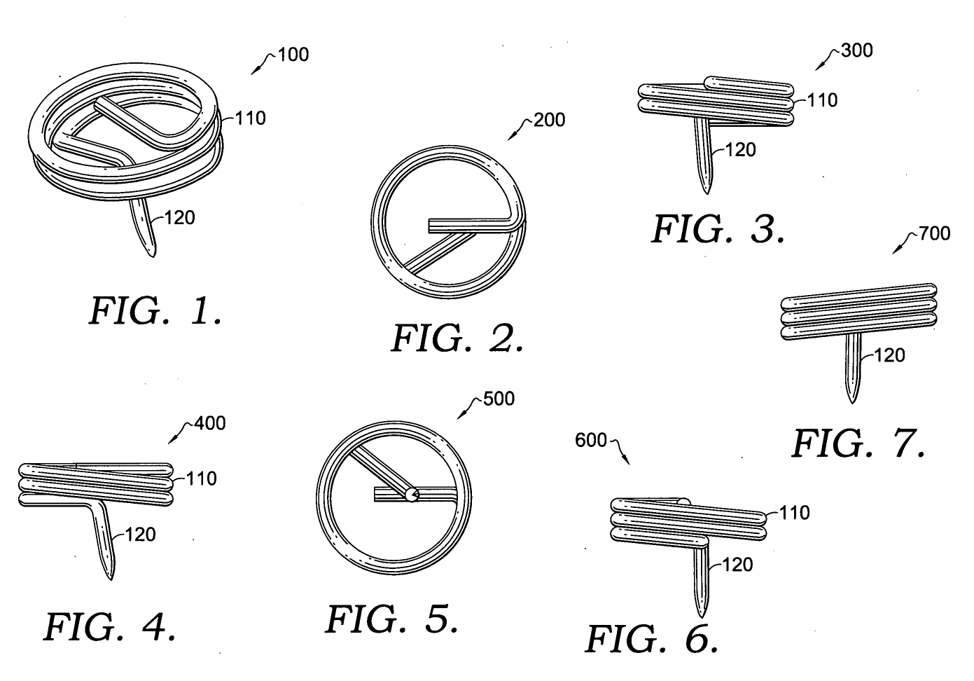

The present invention provides a paper tack which may be implemented in various embodiments. In FIG. 1, a perspective view 100 illustrates an embodiment of a paper tack with a set of looped material 110 curved upon itself. Material 110 may be formed in any manner including string-shaped or strand. For example, material 110 may be cylindrical, square, trapezoidal or triangular shape to name a few. Material 110 is shaped long enough to form a loop, circuitous shape, or coil. In this context, a circuitous shape means that the material should be shaped in a roundabout fashion or eventually connect together but not necessary be circular.

Material 110 extends into a pointed end 120. Pointed end 120 may take the form of a conical edge but may also include a set of tapered sides. Such tapered sides may be in the form of facets. Pointed end 120 may be located substantially perpendicular to material 120. As illustrated in FIG. 1, pointed end 120 angles down and outward from material 110. In FIG. 1, pointed end 120 is located near the center of material 110 but points out. However, in another embodiment of the present invention, pointed end 120 may extend outward from material 110 at one of its sides.

Material 110 may be implemented in an embodiment such that a thin material may be inserted between two adjacent sides within material 110. For example, a piece of paper may be inserted between two of the set of looped material 110. Two adjacent sides of the material 110 are located such that they touch or abut each other. This position allows the two adjacent sides to hold the thin material such as paper. Other items may be inserted as well that can be held by material 110.

Material 110 may be constructed from various materials including metal or plastic. Material 110 is not limited to metal or plastic but may also be constructed from other materials providing for a fairly rigid form. Other material might include fiberglass, polymers, etc.

Pointed end 120 is shaped and positioned such that a user may push material 110 toward a surface causing pointed end 120 to insert into the surface. The conical edge or tapered sides allows material 110 to be inserted at pointed end 120 and held in place at the surface. One can envision material 110 being inserted into a wall at pointed end 120 and holding a piece of paper. The surface may include, but not limited to, a wall, ceiling, or floor.

In FIGS. 2-7, additional views of an implementation of the embodiment of the present invention is shown that describe the same or similar elements as described in FIG. 1. In FIG. 2, a top-side elevational view 200 is shown. In FIG. 3, a front elevational view 300 is shown with material 110 and pointed end 120. In FIG. 4, a right-side elevational view 400 is shown with material 110 and pointed end 120. In FIG. 5, a bottom elevational view 500 is shown. In FIG. 6, a back elevational view 600 is shown with material 110 and pointed end 120. In FIG. 7, a left-side elevational view 700 is shown with material 110 and pointed end 120.

Many different arrangements of the various components depicted, as well as components not shown, are possible without departing from the spirit and scope of the present invention. Embodiments of the present invention have been described with the intent to be illustrative rather than restrictive. Alternative embodiments will become apparent to those skilled in the art that do not depart from its scope. A skilled artisan may develop alternative means of implementing the aforementioned improvements without departing from the scope of the present invention.

It will be understood that certain features and subcombinations are of utility and may be employed without reference to other features and subcombinations and are contemplated within the scope of the claims. Not all steps listed in the various figures need be carried out, or carried out at all in some instances, in the specific order described.

The invention claimed is:

1. An apparatus for embedding into a first object, comprising:
a string-shaped material having a set of coiled loops abutting each other for holding a second object between a pair of the set of coiled loops;
the string-shaped material extending a first linear piece from one end of the set of coiled-loops radially perpendicular to one member of the set of coiled loops;
the string-shaped material extending a second linear piece angularly substantially perpendicular to the first linear piece wherein the second linear piece extends outwardly away from the set of coiled loops; and
the second linear piece having a substantially conical edge such that the substantial conical edge embeds into the first object.

2. The apparatus of claim 1, wherein the string-shaped material is selected from a group including metal and plastic.

3. The apparatus of claim 2, wherein the substantial conical edge includes one or more flat faces.

4. The apparatus of claim 3 wherein the first object is selected from a group including a wall, a ceiling, and a floor.

5. The apparatus of claim 4, wherein the second object is selected from a group including a paper.

6. The apparatus of claim 1, further comprising the string-shaped material extending a third linear piece from an opposite end of the set of coiled-loops wherein the third linear piece extends radially perpendicular to another member of the set of coiled loops.

7. An apparatus for holding an item, comprising:
a strand of material with a circuitous shape such that a substantial first portion of a first side of the strand of material touches a substantial second portion of an opposite side of the strand of material; and
a first linear piece located at a first end of the strand of material wherein the first linear piece extends outwardly from the strand of material and wherein the first linear piece comprises a pointed end.

8. The apparatus of claim 7, wherein the substantial first portion and the substantial second portion are shaped to hold an object.

9. The apparatus of claim 8, wherein the object is selected from a group including a thin material.

10. The apparatus of claim 9, wherein the first linear piece with the pointed end extends substantially perpendicular to the strand of material.

11. The apparatus of claim 10, further comprising a second linear piece located between the first end of the strand of material and the first linear piece wherein the second linear piece extends from the first end radially perpendicular to the strand of material.

12. The apparatus of claim 11, wherein the first linear piece is located perpendicular to the second linear piece and extends outwardly from the radial center of the strand of material.

13. The apparatus of claim 12, wherein the strand of material forms a coil.

14. The apparatus of claim 13, wherein the strand of material is selected from a group including metal and plastic.

15. The apparatus of claim 14, wherein the pointed end includes one or more flat faces.

16. The apparatus of claim 7, further comprising a second end of the strand of material extending linearly from the strand of material wherein the second end extends radially perpendicular to the strand of material.
